(19) United States
(12) Patent Application Publication
(10) Pub. No.: US 2010/0111334 A1
(43) Pub. Date: May 6, 2010

(54) SPEAKER AND ELECTRONIC APPARATUS USING THE SAME

(75) Inventors: Takeshi Simokawatoko, Mie (JP); Koji Sano, Mie (JP); Kazuki Honda, Mie (JP); Mitsukazu Kuze, Mie (JP); Shinya Mizone, Mie (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/595,548

(22) PCT Filed: Jul. 14, 2008
(86) PCT No.: PCT/JP2008/001879

§ 371 Date: Oct. 12, 2009

(30) Foreign Application Priority Data
Jul. 25, 2007 (JP) 2007-192810

(51) Int. Cl. H04R 25/00

(52) U.S. Cl. 381/182

(57) ABSTRACT

In a loudspeaker, three magnets are disposed with magnetic gaps formed between them for placing therein a voice coil. The magnets disposed at two sides are so magnetized that the confronting poles have the same polarity. The magnet in the center has its magnetic poles in a direction perpendicular to a direction connecting the poles of the magnets at two sides. A diaphragm has an aperture formed in a position confronting the center magnet. Also provided is a magnetic fluid kept mediating between the sides of the center magnet facing the magnetic gaps and the voice coil.

### TECHNICAL FIELD

The present invention relates to a low-profile loudspeaker and an electronic apparatus using the same.

### BACKGROUND ART

With the demand for sliming down of electronic apparatuses such as portable devices, there are also growing demands for reducing thickness of loudspeakers built into their housing cases.

It is the common practice to reduce dimensions of a magnet that forms a magnetic circuit in order to reduce the thickness of a conventional loudspeaker such as the one described in the Patent Literature 1 below. When the magnet is reduced in size, a magnetic force of it weakens, which in turn decreases a sound output. It is thus impractical to reduce substantially the size of the magnet, and therefore not feasible to achieve a significant reduction in the thickness of the conventional loudspeaker.

Patent literature 1: Japanese Patent Unexamined Publication, No. 2005-51283.

### SUMMARY OF THE INVENTION

The present invention discloses a low-profile loudspeaker having a high sound output and robustness capable of withstanding vibrations and physical shocks. The loudspeaker of the present invention has a first magnet, a second magnet, a third magnet, a voice coil, a diaphragm and a magnetic fluid. The first magnet has a first pole and a second pole of an opposite polarity to that of the first pole. The second magnet has a third pole of the same polarity as the first pole of the first magnet and a fourth pole of the same polarity as the second pole, and is so disposed that the third pole confronts the first pole of the first magnet. The third magnet has a fifth pole of the same polarity as the first pole of the first magnet and a sixth pole of the same polarity as the second pole, and is disposed in such an orientation that an axial direction connecting the fifth pole and the sixth pole is perpendicular to a line connecting the first pole of the first magnet and the third pole of the second magnet, and that the sixth pole is positioned closer to the first and the third poles. There are magnetic gaps, one formed between the third magnet and the first magnet, and another formed between the third magnet and the second magnet. The voice coil is placed in these magnetic gaps. The diaphragm supports the voice coil. The diaphragm is provided with an aperture formed in a position confronting the third magnet. The magnetic fluid is kept suspended between the sides of the third magnet facing the magnetic gaps and the voice coil.

By virtue of the above structure, the loudspeaker of the present invention is provided with magnetic flux of a direction substantially perpendicular to the voice coil within the magnetic gaps while achieving a reduction in the thickness. In addition, the above arrangement of the three magnets enhances the magnetic force to increase the sound output. Moreover, the magnetic fluid helps prevent a rolling phenomenon and reduces gap failures. Furthermore, the magnetic fluid also improves the effect of heat dissipation from the voice coil and increases a resistance of the loudspeaker against high input. In this structure, vibration of the diaphragm is not impeded since the diaphragm is provided with the aperture in the position confronting the third magnet.

### BRIEF DESCRIPTION OF THE DRAWINGS

FIG. 1 is a perspective view of a mobile phone unit equipped with a loudspeaker according to an exemplary embodiment of the present invention.

FIG. 2 is a perspective view of the mobile phone unit shown in FIG. 1 with a cover thereof removed.

FIG. 3 is a block diagram of the mobile phone unit shown in FIG. 1.

FIG. 4 is an exploded perspective view of the loudspeaker shown in FIG. 2.

FIG. 5 is another exploded perspective view of the loudspeaker as in FIG. 4, showing a flow of magnetic flux.

FIG. 6 is a longitudinal sectional view of the loudspeaker shown in FIG. 2.

FIG. 7. is a cross sectional view of the loudspeaker shown in FIG. 2.

FIG. 8 is a enlarged cross sectional view of a portion marked A in FIG. 7.

### REFERENCE MARKS IN THE DRAWINGS

1 Body
2 Lid
3 Cover
4 Loudspeaker
4A Case
5, 6 Plate
5A Sound hole
5B, 7A Adhesive agent
6A Fixing section
6B Opening
7 Third magnet
8, 11 Ring
9 Diaphragm
9A Top portion
9B, 9C Side portion
9D Barrel portion
10 Voice coil
12A First magnet
12B Second magnet
13 Frame
14 Magnetic fluid
15 Aperture
41 Circuit section
42 Input section
43 Microphone
44 Display section
45 Loudspeaker

### DETAILED DESCRIPTION OF PREFERRED EMBODIMENT

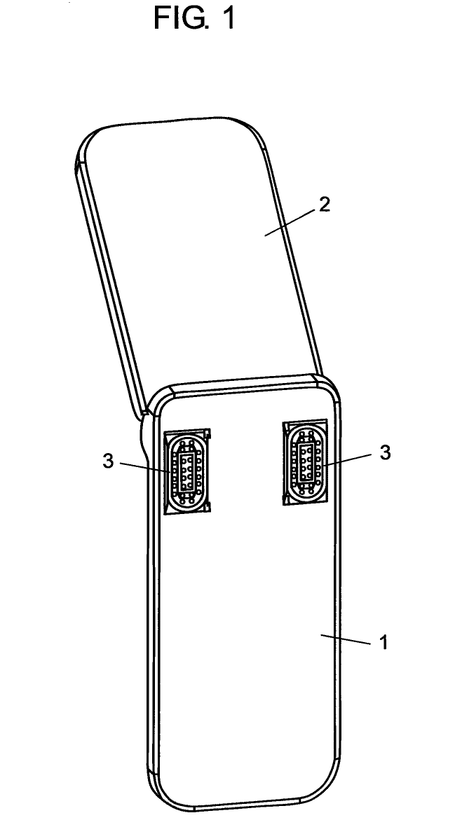

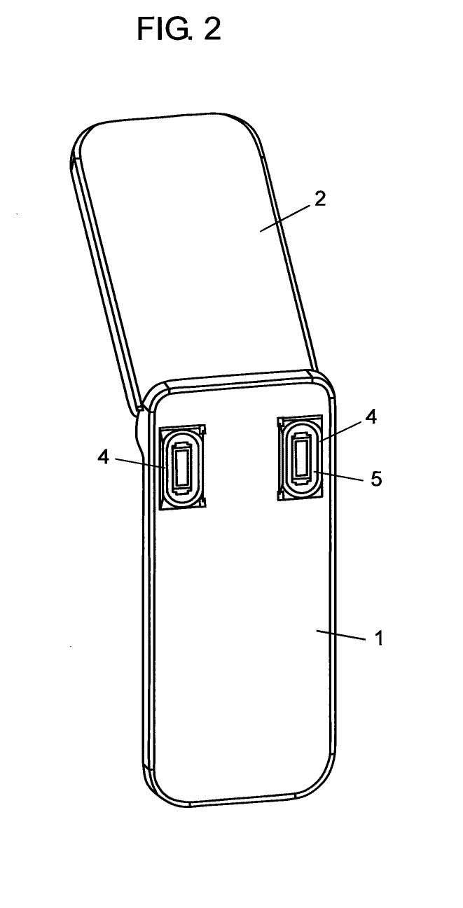

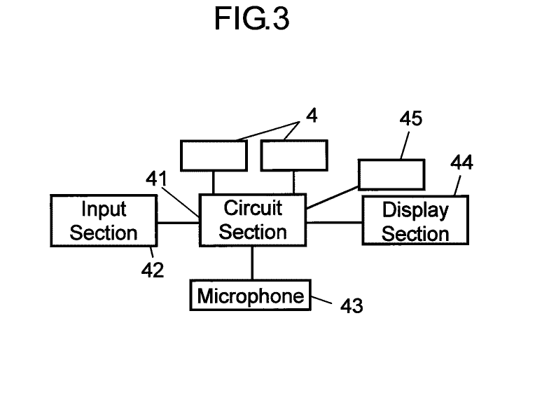

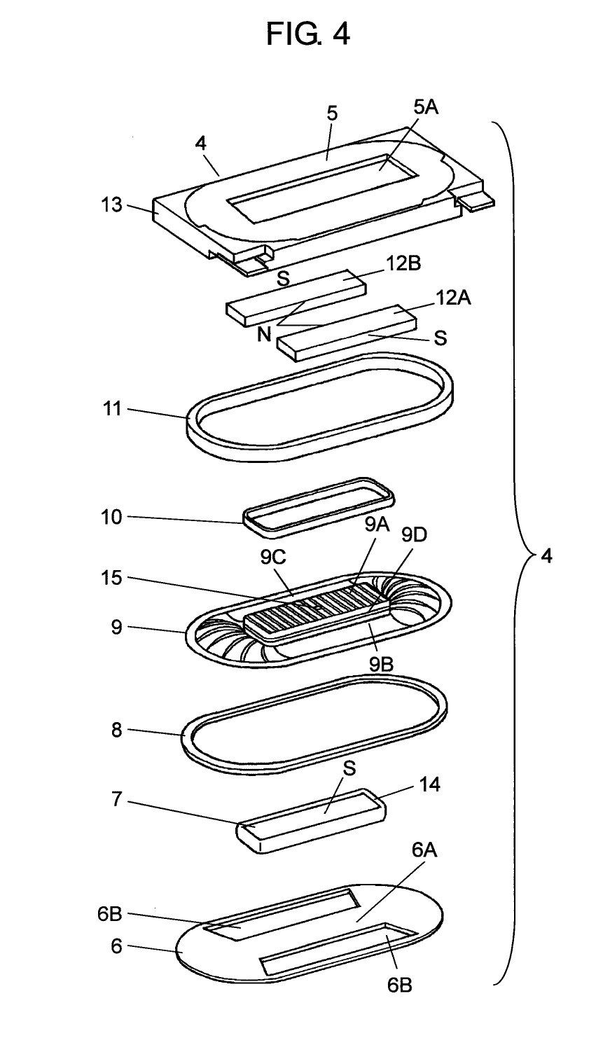

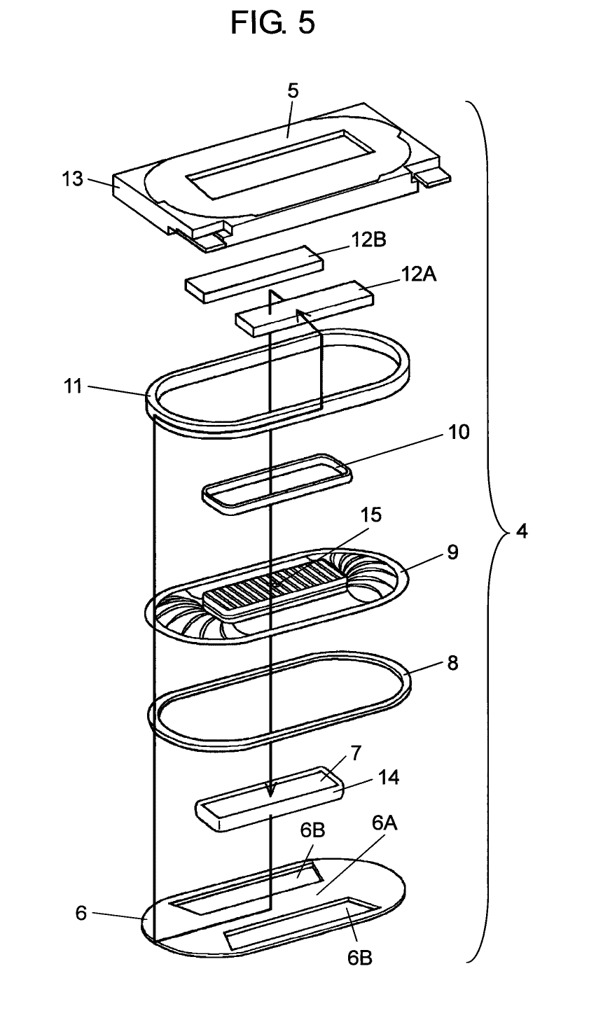

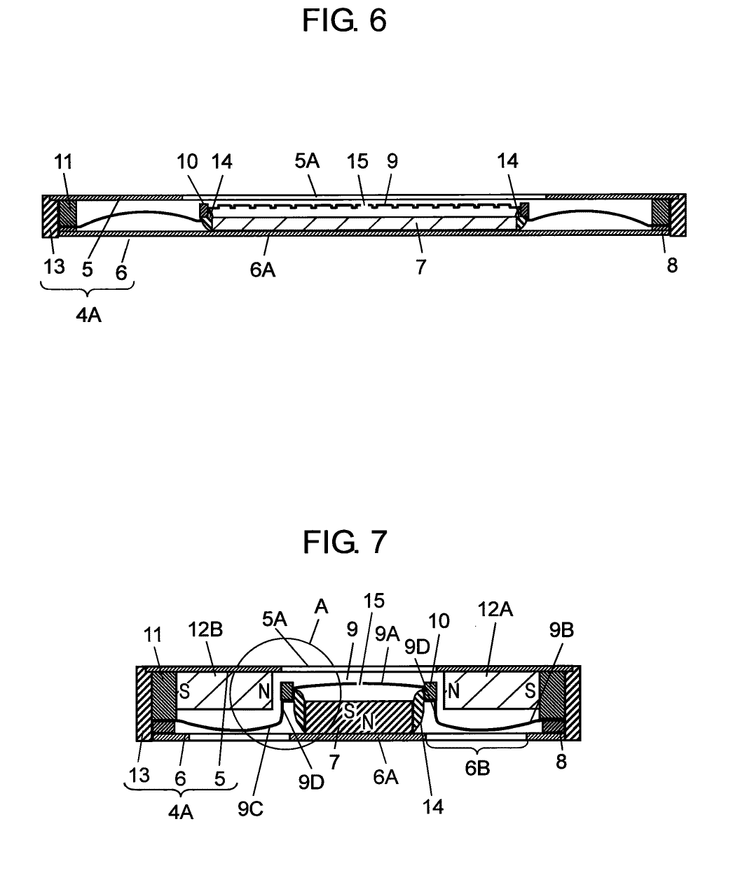

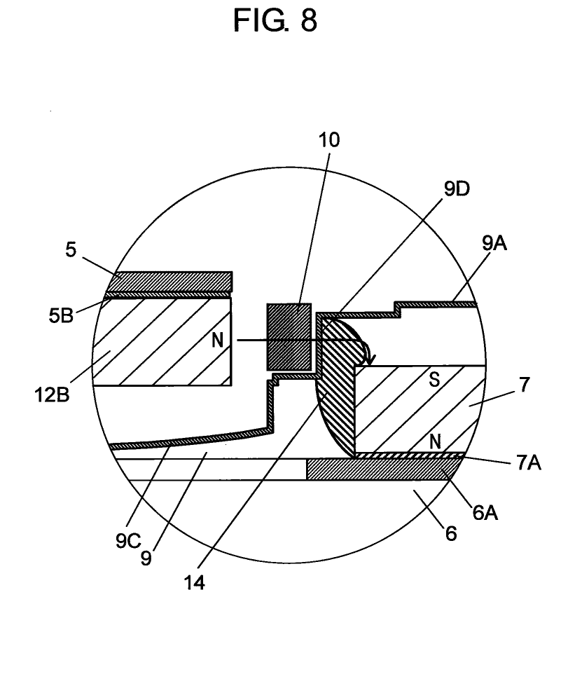

Referring now to the accompanying drawings, description is provided hereinafter of an exemplary embodiment of the present invention by using a mobile phone unit as an example of electronic apparatus. FIG. 1 is a perspective view of a mobile phone unit equipped with a loudspeaker according to this exemplary embodiment of the invention. FIG. 2 is a perspective view of the mobile phone unit shown in FIG. 1 with a cover removed, and FIG. 3 is a block diagram of the mobile phone unit shown in FIG. 1. FIG. 4 and FIG. 5 are exploded perspective views of the loudspeaker shown in FIG. 2, wherein FIG. 5 shows a flow of magnetic flux. FIG. 6 is a longitudinal sectional view and FIG. 7 is a cross sectional view of the loudspeaker shown in FIG. 2. FIG. 8 is an enlarged cross sectional view of a portion marked A in FIG. 7.

The mobile phone unit as an electronic apparatus is provided with two pieces of cover 3 on an outer surface of body 1 as shown in FIG. 1, and loudspeakers 4 are mounted inside body 1 behind each of covers 3 as shown in FIG. 2.

Lid 2 is attached to body 1 in a freely openable manner. Like any ordinary mobile phone, this mobile phone unit is also provided with input section 42 formed of operation buttons and microphone 43 shown in FIG. 3 on the side of body 1 opposite the side illustrated in FIG. 1. Lid 2 has display section 44 of an LCD and loudspeaker 45 for receiving conversation. Circuit section 41 housed inside body 1 receives an input from input section 42, and displays the input, incoming information and the like on display section 44. During a telephone conversation, circuit section 41 receives a voice input from microphone 43, and reproduces an incoming voice of another party via loudspeaker 45. In addition, circuit section 41 drives loudspeakers 4 to generate a ring tone.

As shown in FIG. 4, loudspeaker 4 has plates 5 and 6, first magnet 12A, second magnet 12B and third magnet 7, each of which has a plate-like shape, rings 8 and 11, diaphragm 9 and voice coil 10. Plate 5 positioned on the exterior side of body 1 is made of a stainless steel having a non-magnetic property (e.g., SUS301). On the other hand, plate 6 is made of a cold rolled steel sheet having a magnetic property. Frame 13 made of a resin covers a part of front surface of plate 5 as well as the periphery of all components, as shown in FIG. 6 and FIG. 7. In other words, plates 5, 6 and frame 13 constitute case 4A. Plate 5 is provided with sound hole 5A.

First magnet 12A, second magnet 12B and third magnet 7, each of the plate-like shape having a longitudinal direction are made of such material as neodymium. Neodymium magnets are suitable for use in small and low-profile loudspeaker 4 of this exemplary embodiment since they exhibit strong magnetic polarities. The material needs not be limited only to neodymium, however, that it can be of any other materials so long as they have strong magnetism. Each of first magnet 12A, second magnet 12B and third magnet 7 has the N-pole and the S-pole. In the embodiment described below, the N-pole of first magnet 12A may be referred to as a first pole while the S-pole may be referred to as a second pole of opposite polarity to that of the first pole. Likewise, the N-pole and the S-pole of second magnet 12B may be referred to as a third pole and a fourth pole of opposite polarity to that of the third pole, and the N-pole and the S-pole of third magnet 7 may also be referred to as a fifth pole and a sixth pole of opposite polarity to that of the fifth pole. It is to be noted, however, that the arrangement of the N-poles and the S-poles of these magnets may entirely be reversed.

Diaphragm 9 is formed of such a material as polyether-imide film. Voice coil 10 is made of a copper wire or the like. Voice coil 10 is oblong in shape having a pair of long sides in plan view, and these long sides are disposed in the magnetic gaps provided at both sides of third magnet 7 along the longitudinal direction. Both rings 8 and 11 are formed of a cold rolled steel sheet having a magnetic property.

Third magnet 7, ring 8, diaphragm 9, voice coil 10, ring 11, first magnet 12A and second magnet 12B are disposed inside case 4A in the above order from plate 6 toward plate 5. Third magnet 7 and ring 8 are disposed on plate 6. Ring 8 is fixed to the peripheral portion of plate 6 in a manner to allow the magnetic flux to pass through as shown by the arrow in FIG. 5.

Plate 6 has an oblong shape as shown in FIG. 4 and FIG. 5, and has fixing section 6A of a rectangular shape in an area of the center axis (i.e., central portion) along its longitudinal direction. Third magnet 7 is fixed to the upper surface of fixing section 6A with adhesive agent 7A applied to the bottom of third magnet 7 as shown in FIG. 8. Plate 6 is also provided with openings 6B of a rectangular shape at both sides of fixing section 6A. Openings 6B serve as back sound holes enabling loudspeaker 4 to radiate sound also from the backside.

Diaphragm 9 is placed with its periphery on ring 8, and ring 11 is placed on the periphery of diaphragm 9. FIG. 5 shows only the magnetic flux originated from first magnet 12A in order to avoid complexity of the drawing.

First magnet 12A and second magnet 12B are fixed in positions above diaphragm 9 in a manner to confront respective openings 6B of plate 6. Parts of adhesive agent 5B are spread to enter into spaces between the peripheral surfaces of first magnet 12A and second magnet 12B and inner surfaces of ring 11 and frame 13. In this way, first magnet 12A and second magnet 12B are also secured to ring 11 and frame 13 with adhesive agent 5B on their peripheral surfaces.

Diaphragm 9 has top portion 9A, side portions 9B and 9C and barrel portion 9D, as shown in FIG. 4 and FIG. 7. Top portion 9A confronts the S-pole of third magnet 7, and side portion 9B confronts one of the surfaces of first magnet 12A other than the N-pole and the S-pole, whereas side portion 9C confronts one of the surfaces of second magnet 12B other than the N-pole and the S-pole. Voice coil 10 of elongated-shape is fixed to the upper surface of diaphragm 9 around its barrel portion 9D corresponding to the outer periphery of third magnet 7. Barrel potion 9D is disposed in the magnetic gaps formed between first magnet 12A and third magnet 7 and between second magnet 12B and third magnet 7. Voice coil 10 is thus located inside the magnetic gaps. Accordingly, diaphragm 9 is so disposed as to separate first magnet 12A and second magnet 12B from third magnet 7.

Magnetic fluid 14 is kept mediating between the sides of third magnet 7 facing the magnetic gaps and voice coil 10. Since voice coil 10 is fixed to the upper surface of diaphragm 9 at a portion corresponding to the outer periphery of third magnet 7, magnetic fluid 14 stays between third magnet 7 and the portion of diaphragm 9 where voice coil 10 is fixed, to be more precise. Diaphragm 9 is provided with aperture 15 in a position confronting third magnet 7. Magnetic fluid 14 is prepared by having ultra-fine magnetic particles of about 10 nm in particle diameter adsorb a surface-active agent, and dispersing the particles in a dispersion medium such as an organic liquid.

First magnet 12A and second magnet 12B are fixed to the bottom surface of plate 5 with adhesive agent 5B. In other words, plate 5 supports first magnet 12A and second magnet 12B by securing their surfaces other than the magnetic pole portions. To be more specific, first magnet 12A is fixed to plate 5 at the portion (i.e., side surface) which is parallel to the axial direction through its magnetic poles. The same also applies to second magnet 12B.

As shown in FIG. 8, first magnet 12A and second magnet 12B are so magnetized as to have the N-poles on their longitudinal side surfaces that confront each other and the S-poles on the opposite side surfaces. In other words, second magnet 12B is placed in such an orientation that its N-pole confronts the N-pole of first magnet 12A.

Third magnet 7 is magnetized to have the S-pole on the upper surface and the N-pole on the lower surface in a direction of the thickness. First magnet 12A, second magnet 12B and third magnet 7 are disposed horizontally or substantially horizontally. This expression of “substantially horizontally” includes such arrangements of first magnet 12A, second magnet 12B and third magnet 7 that they overlap partially in the direction of their thickness as shown in FIG. 7, or that they are close to each other without overlapping in the direction of their thickness. As described, third magnet 7 is disposed in such an orientation that the axial direction connecting the N-pole and the S-pole is perpendicular to the direction connecting the N-pole of first magnet 12A and the N-pole of second magnet 12B, and that the S-pole of third magnet 7 is at the side closer to the N-pole of first magnet 12A and the N-pole of second magnet 12B. First magnet 12A, second magnet 12B and third magnet 7 are hence disposed so that their longitudinal sides become parallel to one another.

In the above arrangement, magnetic fluxes originated from the N-poles at the inner sides of respective first magnet 12A and second magnet 12B travel inward in a direction generally horizontally and traverse voice coil 10 substantially orthogonally, as shown in FIG. 5 and FIG. 8. The magnetic fluxes then reach the S-pole on the upper surface of third magnet 7 through magnetic fluid 14. In other words, the magnetic fluxes can traverse voice coil 10 substantially orthogonally because of the horizontal arrangement of first magnet 12A, second magnet 12B and third magnet 7. In this respect, a certain degree of tolerance is allowable in the arrangement of horizontality.

The magnetic fluxes exiting from the N-pole on the lower surface of third magnet 7 then travel through fixing section 6A of plate 6 and enter into ring 11 after passing through ring 8 and the outer periphery diaphragm 9. The magnetic fluxes then travel through ring 11 for about a quarter turn, for instance, and reach the S-poles on the outer sides of first magnet 12A and second magnet 12B fixed to the inner periphery of ring 11. As described, rings 8, 11 and plate 6 constitute a magnetic circuit structuring unit for magnetically coupling the S -poles of first magnet 12A and second magnet 12B and the N-pole of third magnet 7.

The above flow path of the magnetic fluxes represents the magnetic circuit. In this magnetic circuit, spaces between the N-poles on the inner sides of first magnet 12A and second magnet 12B and the S-pole on the upper surface of third magnet 7 serve as the magnetic gaps. The magnetic fluxes in these magnetic gaps impart an electromagnetic motive force to voice coil 10, which is transmitted to diaphragm 9 fixed to voice coil 10 in a form of vibration to generate a sound output.

Here, description is again provided of how the magnetic fluxes travel in the magnetic gaps. As shown in FIG. 5 and FIG. 8, the magnetic fluxes originated from the N-poles at the inner sides of respective first and second magnets 12A and 12B travel inward in the direction substantially horizontally in the magnetic gaps and traverse voice coil 10 substantially orthogonally. This is of significant importance in view of increasing the electromagnetic motive force, and constitutes a major feature in this exemplary embodiment.

Consideration is given now to the reason why the magnetic fluxes travel inward in the direction generally horizontally in the magnetic gaps and traverse voice coil 10 substantially orthogonally.

It is generally considered that the magnetic fluxes originated from the N-poles of first magnet 12A and second magnet 12B travel in a slanting direction toward the S-pole on the upper surface of third magnet 7. If this is the case, the magnetic fluxes traverse voice coil 10 slightly slantly. In reality, however, the N-pole on the lower surface of third magnet 7 exerts a repelling force upon the magnetic fluxes to lift and make them travel inward across the magnetic gaps in generally the horizontal direction as shown in FIG. 8. It is hence considered for this reason that the magnetic fluxes traverse voice coil 10 substantially orthogonally.

According to the present exemplary embodiment as described above, first magnet 12A and third magnet 7 are disposed to form the two sides of the magnetic gap, and second magnet 12B and third magnet 7 are disposed to form the two sides of another magnetic gap. This increases the so-called magnetic force, thereby resulting in an enhancement of the sound output generated by diaphragm 9. In addition, an overall thickness of loudspeaker 4 is significantly reduced as a result since all of first magnet 12A, second magnet 12B and third magnet 7 have the plate-like shape of low profile.

Furthermore, magnetic fluid 14 is kept to mediate between the sides of third magnet 7 and voice coil 10. Magnetic fluid 14 can suppress a rolling phenomenon. It also improves the effect of heat dissipation from voice coil 10 thereby increasing a resistance of voice coil 10 against high input. In addition, magnetic fluid 14 contributes to the ease of positioning voice coil 10 in a process of disposing voice coil 10 over third magnet 7, which reduces a gap failure.

Diaphragm 9 is provided with aperture 15 in a position confronting third magnet 7. Aperture 15 allows free circulation of the air in a space enclosed by third magnet 7, diaphragm 9 and magnetic fluid 14 without obstruction, so as not to impede vibration of diaphragm 9.

Furthermore, first magnet 12A and second magnet 12B are fixed to the lower surface of plate 5 with adhesive agent 5B on their upper surfaces having large surface areas. This can provide a high strength against vibrations and shocks exerted on case 4A. Likewise, third magnet 7 is fixed to the upper surface of plate 6 with adhesive agent 7A on the lower surface having a large surface area. This also helps improve the strength against the vibrations and shocks exerted on case 4A.

Moreover, plate 5 is free from causing a magnetic short-circuit even though it covers the entire upper surfaces of first magnet 12A and second magnet 12B having the N-poles and the S-poles on both sides thereof since plate 5 is made of a non-magnetic material. On the other hand, plate 6 does not adversely influence to formation of the magnetic circuit shown in FIG. 4 even though it covers the entire lower surfaces of third magnet 7 having the S-pole and the N-pole on both upper and lower surfaces since plate 6 is made of a magnetic material. Plate 6 rather helps, in combination with ring 11, to magnetically couple between the S-pole of first magnet 12A and the N-pole of third magnet 7 as well as the S-pole of second magnet 12B and the N-pole of third magnet 7. This structure thus obviates formation of an undesired magnetic gap within the magnetic circuit.

Plate 6 is provided with openings 6B. Openings 6B prevent barrel portion 9D, which is the edge portion of diaphragm 9, from hitting on plate 6 while diaphragm 9 is in vibration. In other words, openings 6B can provide an adequate space for the vibration of barrel portion 9D, which helps reduce the thickness of loudspeaker 4. In addition, the structure constructed as above can increase the magnetic flux density since it reduces a distance from third magnet 7 to first magnet 12A and second magnet 12B. As a result, this structure can compensate for a deficiency of the magnetic flux density due to the reduction in the thickness.

Although plate 5 illustrated in this exemplary embodiment is designed to secure both first magnet 12A and second magnet 12B, plate 5 may be split into two parts to secure first magnet 12A and second magnet 12B individually with the split parts. In such a configuration, a space between these parts serves as the sound hole. It is easier to manufacture, however, when plate 5 is formed to cover the entire diaphragm 9 and both first magnet 12A and second magnet 12B are fixed to it.

Loudspeaker 4 may be constructed without using frame 13, and built directly into an electronic apparatus. It is also easier to manufacture, however, when case 4A is formed with frame 13.

Aperture 5A provided in plate 5 is illustrated as having a rectangular shape in a manner to expose diaphragm 9. However, this is not restrictive, and that it may instead be composed of, for instance, a plurality of small circular holes.

### INDUSTRIAL APPLICABILITY

As described above, the loudspeaker of the present invention has three magnets, all positioned horizontally or generally horizontally over the magnetic gaps for disposing the voice coil. This structure helps make magnetic fluxes traverse the voice coil generally orthogonally even though the magnets have thin plate-like shapes. As a result, the invented structure can increase the magnetic force and hence the sound output while also achieving a reduction in the thickness of the loudspeaker. The loudspeaker is also provided with the magnetic fluid kept mediating between the sides of the third magnet disposed at the center and the voice coil, and the diaphragm having the aperture formed in the position confronting the third magnet. This structure helps suppress the rolling phenomenon and reduces gap failures. It also improves the effect of heat dissipation from the voice coil and increases the resistance of the loudspeaker against high input. The loudspeaker constructed as above is very useful for any electronic apparatus including portable equipment such as a mobile phone.

1. A loudspeaker comprising:
a first magnet having a first pole and a second pole of an opposite polarity to that of the first pole;
a second magnet having a third pole of the same polarity as the first pole and a fourth pole of the same polarity as the second pole, the second magnet so disposed that the third pole confronts the first pole of the first magnet;
a third magnet having a fifth pole of the same polarity as the first pole and a sixth pole of the same polarity as the second pole, the third magnet disposed in an orientation that an direction connecting the fifth pole and the sixth pole is perpendicular to a direction connecting the first pole and the third pole, and the sixth pole is located closer to the first and the third poles, the third magnet forming a magnetic gap in each of spaces provided with respect to the first magnet and the second magnet;
a voice coil placed in the magnetic gap;
a diaphragm supporting the voice coil and being provided with an aperture in a position confronting the third magnet; and
a magnetic fluid kept mediating between each side of the third magnet facing the magnetic gap and the voice coil.

2. The loudspeaker according to claim 1, wherein the first magnet, the second magnet, the third magnet and the voice coil are so disposed that a magnetic flux traverses the voice coil substantially orthogonally.

3. The loudspeaker according to claim 1 further comprising a magnetic circuit structuring unit magnetically coupling the second pole, the fourth pole and the fifth pole.

4. The loudspeaker according to claim 3, wherein the fifth pole of the third magnet has a flat surface fixed to the magnetic circuit structuring unit.

5. The loudspeaker according to claim 1 further comprising a plate made of a non-magnetic material, the plate supporting a portion of the first magnet other than the first pole and the second pole, and a portion of the second magnet other than the third pole and the fourth pole.

6. The loudspeaker according to claim 5 further comprising a magnetic circuit structuring unit magnetically coupling the second pole, the fourth pole and the fifth pole,
wherein the plate and the magnetic circuit structuring unit form a case housing the first magnet, the second magnet, the third magnet, the voice coil and the diaphragm.

7. The loudspeaker according to claim 5, wherein the first magnet has a flat surface on a portion other than the first pole and the second pole, the second magnet has a flat surface on a portion other than the third pole and the fourth pole, and both the first magnet and the second magnet are fixed to the plate with their flat surfaces.

8. The loudspeaker according to claim 7, wherein the plate covers the diaphragm.

9. The loudspeaker according to claim 8, wherein the plate is provided with a sound hole in a position confronting the diaphragm.

10. The loudspeaker according to claim 1,
wherein each of the first magnet, the second magnet and the third magnet is of a plate-like shape having a longitudinal direction;
the first magnet, the second magnet and the third magnet are arranged in parallel to one another along the longitudinal direction; and
the voice coil is oblong in shape having a pair of long sides in plan view, and the long sides are disposed in the magnetic gaps provided at both sides of third magnet along the longitudinal direction.

11. An electronic apparatus comprising:
the loudspeaker according to claim 1; and
a circuit configured to drive the loudspeaker.
